(19) United States
(12) Patent Application Publication
(10) Pub. No.: US 2026/0247398 A1
(43) Pub. Date: Aug. 20, 2026

(54) DOWNLINK CONTROL INFORMATION INTERPRETATION FOR HYBRID AUTOMATIC REPEAT REQUEST DISABLED RESOURCES

(71) Applicant: QUALCOMM Incorporated, San Diego, CA (US)

(72) Inventors: Morteza SOLTANI, San Diego, CA (US); Mostafa KHOSHNEVISAN, San Diego, CA (US); Jing SUN, San Diego, CA (US); Jae Ho RYU, San Diego, CA (US)

(21) Appl. No.: 19/057,410

(22) Filed: Feb. 19, 2025

(51) Int. Cl. H04W 72/232; H04L 1/1812; H04L 5/00; H04W 72/11

(52) U.S. Cl. CPC H04W 72/232; H04L 1/1812; H04L 5/0055; H04W 72/11

(57) ABSTRACT

Certain aspects of the present disclosure provide techniques for receiving downlink control information (DCI) associated with a hybrid automatic repeat request (HARQ)-disabled resource; and processing a communication on the HARQ-disabled resource in accordance with one or more fields of the DCI or an identifier of the DCI, wherein the one or more fields or the identifier are interpreted based on the DCI being associated with the HARQ-disabled resource.

### INTRODUCTION

### Field of the Disclosure

Aspects of the present disclosure relate to wireless communications, and more particularly, to techniques for downlink control information interpretation for hybrid automatic repeat request disabled resources.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

Certain aspects provide a method for wireless communications by a user equipment (UE). The method includes receiving downlink control information (DCI) associated with a hybrid automatic repeat request (HARQ)-disabled resource; and processing a communication on the HARQ-disabled resource in accordance with one or more fields of the DCI or an identifier of the DCI, wherein the one or more fields or the identifier are interpreted based on the DCI being associated with the HARQ-disabled resource.

Certain aspects provide a method for wireless communications by a network entity. The method includes transmitting DCI associated with a HARQ-disabled resource; and transmitting a communication on the HARQ-disabled resource in accordance with one or more fields of the DCI or an identifier of the DCI, wherein the one or more fields or the identifier are interpreted based on the DCI being associated with the HARQ-disabled resource.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of network entities and a user equipment (UE).

FIGS. 4A, 4B, 4C, and 4D depict various example aspects of data structures for a wireless communications network.

FIG. 5 provides an example of hybrid automatic repeat request (HARQ)-enabled downlink transmission and an example of HARQ-disabled downlink transmission

FIG. 6 is a diagram illustrating an example of signaling associated with interpretation of downlink control information (DCI) fields for HARQ-disabled downlink transmission.

FIG. 7 is a diagram illustrating an example 700 of indication of a HARQ-disabled configuration associated with a semi-persistent (SPS) configuration.

FIG. 8 depicts a method for wireless communications.

FIG. 9 depicts another method for wireless communications.

FIG. 10 depicts aspects of an example communications device.

FIG. 11 depicts aspects of an example communications device.

### DETAILED DESCRIPTION

Aspects of the present disclosure provide apparatuses, methods, processing systems, and computer-readable mediums for hybrid automatic repeat request (HARQ) disabled feedback transmission.

Wireless communications are prone to failure. For example, a receiver of a wireless communication may encounter an error when attempting to decode the wireless communication. One technique for mitigating errors in wireless communication is an automatic repeat request (ARQ), by which a receiver requests retransmission of a wireless communication associated with an error. Another technique for mitigating errors in wireless communication is error correction, by which multiple copies or versions of a wireless communication are combined (sometimes in a process called soft combining) to attempt to successfully decode the wireless communication.

Some wireless communication technologies have adopted a combination of ARQ and error correction referred to as hybrid ARQ (HARQ). In HARQ, a receiver detects an error in a wireless communication and stores (e.g., buffers) the wireless communication, such as a log likelihood ratio (LLR) derived from the wireless communication. The receiver also requests a retransmission of the wireless communication. The receiver attempts to combine the stored information from the wireless communication and the retransmission of the wireless communication. The receiver may request the retransmission via a HARQ acknowledgment (HARQ-ACK, also referred to herein as feedback or HARQ feedback) that indicates whether or not a wireless communication was received. A HARQ-ACK can include an acknowledgement that a communication was successfully received, or a negative acknowledgment (NACK) indicating that the communication was not successfully received.

Wireless communications and HARQ-ACKs experience delay when traveling via a wireless channel, and when being processed at a receiver or transmitter. To mitigate the impact of this delay, a wireless communication can be assigned one of multiple HARQ process identifiers (IDs). For example, a serving cell may be associated with a set of HARQ processes (e.g., up to 16 HARQ processes). When allocating a resource for a communication, a network entity may signal a HARQ process, from the set of HARQ processes, assigned for the communication. The network entity may also signal an indication of an uplink resource for a HARQ-ACK associated with the communication or the HARQ process. A UE receiving the communication may transmit a HARQ-ACK associated with the HARQ process on the uplink resource. If the HARQ-ACK indicates successful decoding, the UE may discard a buffered version of the communication. If the HARQ-ACK indicates unsuccessful decoding (a negative ACK (NACK)), the UE may store the buffered version of the communication until a retransmission of the communication, scheduled with the same HARQ process ID, is received. Multiple HARQ processes can operate in parallel, each using a different HARQ process ID. Thus, the impact of waiting for a HARQ-ACK and corresponding retransmission to propagate via the wireless channel and be processed is reduced relative to an approach where only a single HARQ process can operate at a given time.

Asynchronous HARQ provides for a non-fixed timing relationship between an initial transmission and a retransmission of the initial transmission. For example, HARQ-ACKs for multiple downlink transmissions that are distributed in time may be transmitted in one uplink data or control region. A retransmission can occupy a different frequency allocation than an initial transmission. In some cases, transmission durations for initial transmissions and/or retransmissions of a given transport block may not be the same as one another.

A HARQ process that requires the UE to store the failed data packet in a buffer and combine retransmitted data packets with parts of failed data packets using a HARQ combining process can help reduce network traffic by reducing the overall number of bits retransmitted by the network entity. This approach, however, is limited by a UE buffer size. Requiring the UE to store failed data packets in the buffer limits the number of downlink (e.g., physical downlink shared channel (PDSCH)) communications that the network entity can transmit before receiving HARQ feedback from the UE. The network entity may be prevented from continuing to transmit downlink communications until the HARQ feedback is received. Otherwise, the network entity may overwhelm the UE's buffer. This may be particularly problematic in the context of carrier aggregation (CA) with different subcarrier spacings (SCSs) for different component carriers (CCs), in which case the UE may be expected to buffer a large number of data transmissions at a given time.

To mitigate UE complexity, the concept of HARQ-disabled downlink transmission has been introduced. In HARQ-disabled downlink transmission, a UE is not expected to buffer an initial retransmission or a retransmission of a communication. For example, the UE may be configured with two sets of HARQ process IDs: a first set of HARQ process IDs for HARQ-enabled downlink transmission (in which communications associated with errors, or LLRs of these communications, are buffered and the UE is expected to perform HARQ combining) and a second set of HARQ process IDs for HARQ-disabled downlink transmission (in which communications or LLRs associated with errors are not buffered and the UE is not expected to perform HARQ combining). The UE may still transmit HARQ-ACKs regarding HARQ-disabled downlink transmissions, but may not buffer an LLR for the HARQ-disabled downlink transmission. Thus, storage overhead at the UE is reduced relative to deploying only HARQ-enabled downlink transmission.

Certain aspects of downlink control information (DCI) are used to signal information for HARQ. For example, a new data indicator (NDI) field may indicate whether a scheduled PDSCH carries new data (that is, an initial transmission) or a retransmission. A redundancy version identifier (RVID) field may indicate which redundancy version is used for an initial transmission or retransmission of a transport block (TB). In some cases, a DCI may indicate a reserved MCS. A reserved MCS specifies a modulation scheme and leaves a code rate to gNB selection. A reserved MCS may be used for cases when a retransmission uses a different number of resources than an initial transmission. For example, if the network retransmits a TB without changing the information bits of the TB, then given that a TB size (TBS) for the TB is already known from an initial transmission of the TB, the network does not need to indicate the TBS through the code rate. Thus, the network can schedule the retransmission more flexibly with regard to parameters such as resource allocation, number of layers, or the like.

Ambiguity may arise regarding how to interpret these fields of DCI for HARQ-disabled transmissions and HARQ-enabled transmissions. For example, a UE that does not perform soft combining of buffered data may obtain limited or no benefit from the NDI or RVID fields in certain scenarios, so these fields may increase overhead or reduce the versatility of the DCI with limited benefit. As another example, it may be uncertain whether usage/indication of a reserved MCS is permitted for HARQ-disabled transmissions, so ambiguity may arise with regard to whether an NDI field is needed (to indicate a reserved MCS is associated with an earlier transmission) or with regard to how to interpret an MCS field of the DCI. Without clarity on how these fields are to be interpreted, overhead may be increased and efficiency of HARQ-disabled communication may be diminished.

Furthermore, HARQ-disabled downlink transmission may be semi-statically activated or deactivated, such as via radio resource control signaling. However, there are situations in which semi-static activation or deactivation may provide limited adaptability and incur greater overhead than other forms of signaling. For example, in a situation where rapid switching between HARQ-disabled downlink transmission and HARQ-enabled downlink transmission is desired, semi-static activation or deactivation of HARQ-disabled downlink transmission may introduce latency and overhead, which may slow adaptation of HARQ-disabled downlink transmission.

Aspects of the present disclosure relate generally to signaling for HARQ-disabled downlink transmission. Some aspects more specifically relate to processing communications on HARQ-disabled resources in accordance with DCI, where certain fields of the DCI are interpreted based on the DCI being associated with (e.g., scheduling the communications on) the HARQ-disabled resources. For example, an NDI field and/or RVID field of the DCI may be interpreted in a fashion that is specific to HARQ-disabled resources. As another example, when a reserved MCS is usable for HARQ-disabled downlink transmission, an NDI field of the DCI may be used to indicate whether the code rate should be derived from an earlier transmission with the same HARQ process ID. As another example, when a reserved MCS is not usable for HARQ-disabled downlink transmission, the DCI may be configured to indicate a non-reserved code rate for a communication on HARQ-disabled resource.

Aspects of the present disclosure may be used to realize one or more of the following potential advantages. By providing processing of certain fields of the DCI that are interpreted based on the DCI being associated with (e.g., scheduling the communications on) the HARQ-disabled resources, ambiguity regarding processing of these fields in this context is eliminated. For example, by using an NDI field of the DCI to indicate whether the code rate should be derived from an earlier transmission with the same HARQ process ID in the context of HARQ-disabled downlink transmission, overhead can be reduced relative to explicitly indicating the updated MCS.

Furthermore, some aspects provide dynamic activation and deactivation of HARQ-disabled downlink transmission. For example, some aspects provide dynamic activation or deactivation of HARQ-disabled operation for a specific HARQ-process ID. This activation or deactivation can originate at the UE or at the network entity. Dynamic activation and deactivation of HARQ-disabled downlink transmission for a specific HARQ process ID may reduce latency and overhead associated with HARQ-disabled downlink communication and provide increased flexibility for HARQ-disabled downlink communication.

Some aspects provide for HARQ-disabled operation to be configured as part of a semi-persistent scheduling (SPS) configuration. For example, HARQ-disabled operation may be configured for a HARQ-disabled resource via SPS configuration. A HARQ process ID can then be used for HARQ-enabled downlink transmission when the corresponding DCI is scrambled using a cell radio network temporary identifier (C-RNTI), or for HARQ-disabled downlink transmission when the corresponding DCI is scrambled using a configured scheduling radio network temporary identifier (CS-RNTI). HARQ-disabled operation being configured as part of an SPS configuration, and usage of HARQ process IDs for either HARQ-enabled downlink transmission when the corresponding DCI is scrambled using a C-RNTI, or for HARQ-disabled downlink transmission when the corresponding DCI is scrambled using a CS-RNTI, improves flexibility of HARQ-disabled communication and allows the network to disable combining for SPS communications (which occur periodically anyway) and enable combining for dynamically scheduled traffic.

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

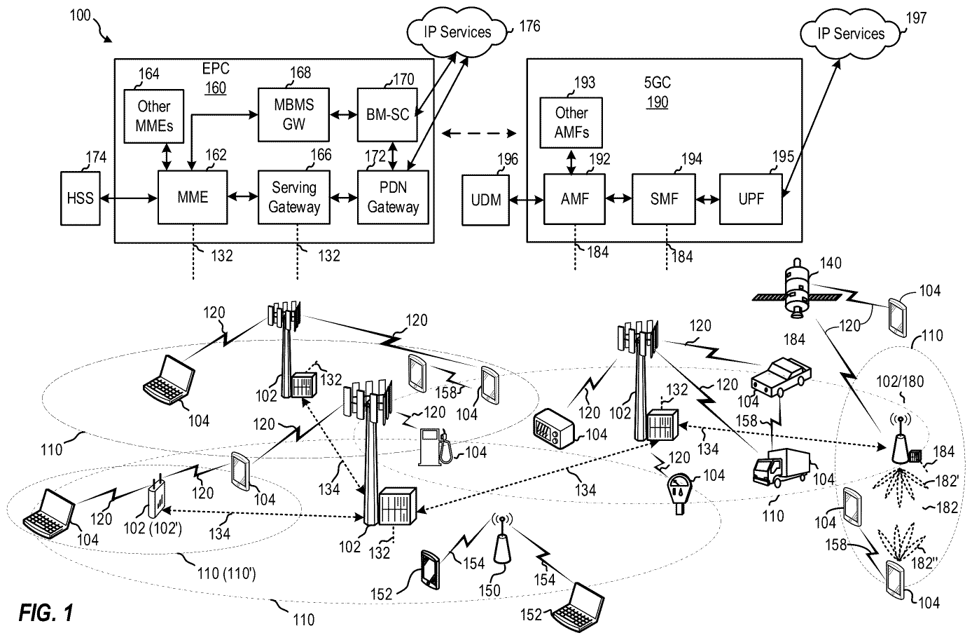

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 may include terrestrial aspects, such as ground-based network entities (e.g., BSs 102), and non-terrestrial aspects (also referred to herein as non-terrestrial network entities). A non-terrestrial network entity may include satellite 140, which may be an example of an aerial or space-borne platform. In some examples, satellite 140 may include one or more network entities on-board (e.g., one or more BSs) capable of communicating with other network elements (e.g., terrestrial BSs) and UEs. For example, satellite 140 may be implemented according to a regenerative architecture (also referred to as a non-transparent architecture), and a gNB implemented at satellite 140 may implement higher-layer network functions. As another example, satellite 140 may be implemented according to a transparent architecture, and may perform a physical or other lower-layer repeater function for UEs and a network entity (such as a gateway associated with the satellite 140).

In the depicted example, wireless communications network 100 includes BSs 102, UEs 104, and one or more core networks, such as an Evolved Packet Core (EPC) 160 or a 5G Core (5GC) network 190, which interoperate to provide communications services over various communications links, including wired and wireless links. In some aspects, a core network, such as a 6G core, may implement a converged service-based architecture. In a converged service-based architecture, functions traditionally split between a core network (such as 5GC network 190) and a radio access network (RAN) (such as BS 102) may be implemented at a single network entity. For example, a mobility network entity may perform both core network functions and RAN functions related to mobility of UEs 104 attached to the wireless communications network 100. “Network entity” can refer to a BS 102, a network entity of EPC 160 or 5GC network 190, or a network entity of a converged service-based architecture.

FIG. 1 depicts various example UEs 104. UE 104 may include a cellular phone, a smart phone, a session initiation protocol (SIP) phone, a laptop, a personal digital assistant (PDA), a satellite radio, a Global Positioning System device, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an Internet of Things (IoT) device, an always on (AON) device, an edge processing device, a data center, or another similar device. A UE 104 may also be referred to as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. A communications link 120 between a BS 102 and a UE 104 may include uplink (UL) (also referred to as reverse link) transmissions from a UE 104 to a BS 102 and/or downlink (DL) (also referred to as forward link) transmissions from a BS 102 to a UE 104. A communications link 120 may use multiple-input and multiple-output (MIMO) antenna technology, including spatial multiplexing, beamforming, and/or transmit diversity in various aspects.

A BS 102 may include a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point (TRP), a radio unit (RU), a distributed unit (DU), or the like. A given BS 102 may provide communications coverage for a coverage area 110, which may sometimes be referred to as a cell, and which may overlap another coverage area 110 (e.g., a small cell provided by a BS 102′) may have a coverage area 110′ that overlaps the coverage area 110 of a macro cell). A BS 102 may, for example, provide communications coverage for a macro cell (covering a relatively large geographic area), a pico cell (covering a relatively smaller geographic area, such as a sports stadium), a femto cell (covering a relatively smaller geographic area, such as a home), or another type of cell.

The term “cell” may refer to a portion, partition, or segment of wireless communication coverage served by a network entity within a wireless communications network 100. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

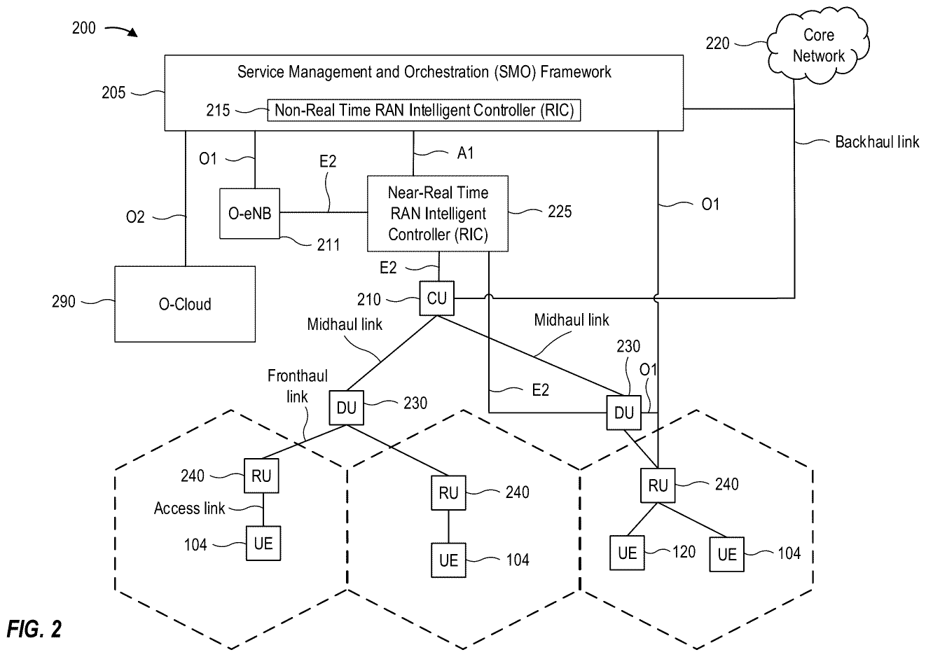

While BSs 102 are depicted in various aspects as unitary communications devices, BSs 102 may be implemented in various configurations. For example, one or more components of a base station may be disaggregated, including a central unit (CU), one or more DUs, one or more RUs, a Near-Real Time (Near-RT) RAN Intelligent Controller (RIC), or a Non-Real Time (Non-RT) RIC, to name a few examples. In another example, various aspects of a base station may be virtualized. A base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. Implementing a base station in this fashion may provide efficiency gains by enabling cloud-based implementation of certain (e.g., non-time-sensitive) higher-layer functions while physical-layer or other lower-layer functions can be implemented at or in proximity to a geographic coverage area of a corresponding cell. In some aspects, a base station including components that are located at various physical locations may be referred to as having a disaggregated RAN architecture, such as an Open RAN (O-RAN) or Virtualized RAN (VRAN) architecture. FIG. 2 depicts and describes an example disaggregated RAN architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or the 5GC 190) with each other over third backhaul links 134 (e.g., an X2 or XN interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, the Third Generation Partnership Project (3GPP) currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

A communications links 120 may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 180 in FIG. 1) may utilize beamforming (indicated by reference number 182) with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182∴. UE 104 may also transmit a beamformed signal to the BS 180 in one or more transmit directions 182″. BS 180 may also receive the beamformed signal from UE 104 in one or more receive directions 182′. BS 180 and UE 104 may perform beam training to determine suitable receive and transmit directions for each of BS 180 and UE 104. Notably, the transmit and receive directions for BS 180 may or may not be the same. Similarly, the transmit and receive directions for UE 104 may or may not be the same.

Wireless communications network 100 may include a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. In some examples, D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). D2D communications link 158 may be implemented using a variety of technologies, such as a radio access technology (e.g., 5G, ProSe sidelink), a WiFi technology, a Bluetooth technology, or the like.

EPC 160 may include various functional components, such as a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172. MME 162 may be in communication with a Home Subscriber Server (HSS) 174. MME 162 is a control node that processes signaling between the UEs 104 and the EPC 160. Generally, MME 162 provides bearer and connection management.

Generally, user Internet protocol (IP) packets are transferred through Serving Gateway 166. Serving gateway 166 is connected to PDN Gateway 172. PDN Gateway 172 provides UE IP address allocation as well as other functions. PDN Gateway 172 and BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, such as an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and the 5GC 190. AMF 192 provides, for example, quality of service (QoS) flow and session management.

IP packets are transferred through UPF 195, which is connected to the IP Services 197. UPF 195 may provide UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a core network entity, or a sidelink node, to name a few examples.

FIG. 2 depicts an example disaggregated base station 200 architecture. The disaggregated base station 200 architecture may include one or more CUs 210 that can communicate directly with a core network 220 or other CUs 210 via a backhaul link (such as backhaul link 134), or indirectly with the core network 220 through one or more disaggregated base station units (such as a Near-Real Time (Near-RT) RAN Intelligent Controller (RIC) 225 via an E2 link, a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links (such as communication link 120). In some implementations, a UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or a processor or controller providing instructions to the interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter, or a transceiver (such as a RF transceiver), configured to receive or transmit signals, or both, over a wireless transmission medium.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may be or correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

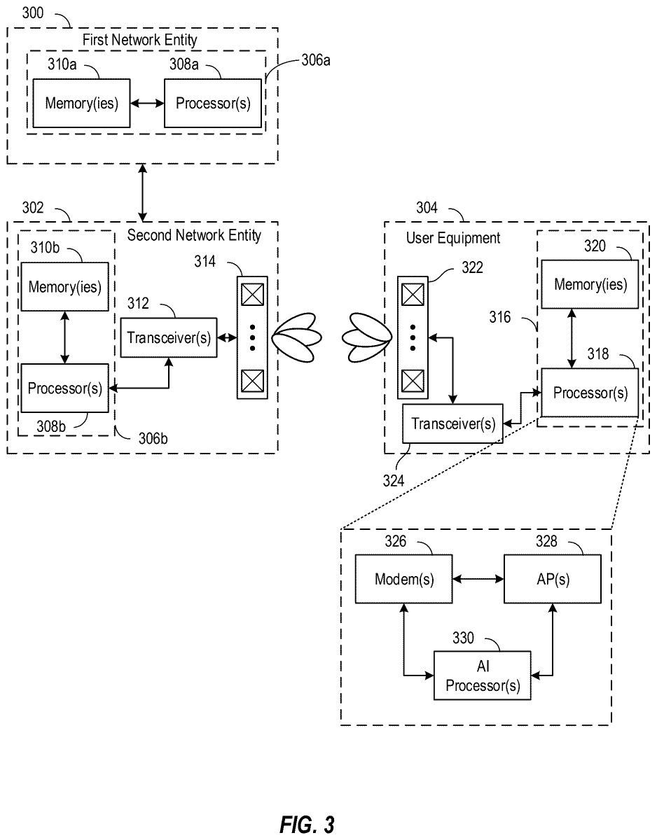

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In s ome examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (e.g., BS 102). For example, first network entity 300 and second network entity 302 may be co-located. In some other examples, first network entity 300 may be implemented separately from second network entity 302. For example, first network entity 300 may be implemented as a function (e.g., one or more processes) running on a server, such as in a cloud (e.g., a public or private cloud). As another example, first network entity 300 may be implemented as a virtual computing instance (e.g., virtual machine, container, etc.) or as a physical server.

First network entity 300 and second network entity 302 each include a processing system 306, illustrated as “processing system 306a” at first network entity 300 and “processing system 306b” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308a” and “processor(s) 308b”) and one or more memories 310 (illustrated as “memory(ies) 310a” and “memory(ies) 310b”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (e.g., radio, air interface) communication with other devices such as UE 304. The one or more transceivers 312 may include one or more radio frequency (RF) components, such as an RF transceiver, a front-end module (e.g., an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

UE 304 may be an example of UE 104. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGAs), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (e.g., via modulation) and/or converts the waveform of a received signal into information (e.g., via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (e.g., for transmissions) or a data sink (e.g., for receptions).

The one or more transceivers 324 may perform processing related to implementing physical layer (e.g., radio, air interface) communication with other devices such as other UEs 304 or second network entity 302. The one or more transceivers 324 may include one or more RF components, such as an RF transceiver, a front-end module (e.g., an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (e.g., a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (e.g., a transmit processor) may process (e.g., encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (e.g., a TX MIMO processor) may perform spatial processing (e.g., precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (e.g., convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (e.g., filter, amplify, downconvert, and digitize) the received signals to obtain input samples. The one or more transceivers 324 and/or the processing system 316 may further process the input samples to obtain received symbols.

The processing system 316 (e.g., modem 326, an RX MIMO detector) may obtain the received symbols, perform MIMO detection on the received symbols if applicable, and provide detected symbols. The processing system 316 (e.g., a modem 326, a receive processor) may process (e.g., de-interleave and decode) the detected symbols. The processing system 316 may provide decoded data for the UE 304 (e.g., to an AP 328) and/or decoded control information (e.g., to a controller/processor of the processing system 316).

For an example uplink transmission or a sidelink transmission from UE 304, the processing system 316 (e.g., modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (e.g., a modem 326, the transmit processor) may also generate reference symbols for a reference signal (e.g., for a sounding reference signal (SRS), a demodulation reference signal, a phase tracking reference signal, or the like). In some examples, the symbols and/or reference signals may be precoded by the processing system 316 (e.g., modem 326, a TX MIMO processor), further processed by the one or more transceivers 324 (e.g., for SC-FDM), and transmitted to second network entity 302.

At second network entity 302, the uplink signals from UE 304 may be received by the one or more antennas 314, conditioned by the one or more transceivers 312 (e.g., filtered, amplified, downconverted, and digitized), detected (e.g., by the processing system 306b such as a modem and/or an RX MIMO detector), and further processed by the processing system 306b (e.g., a modem and/or a receive processor) to obtain decoded data and control information sent by UE 304. The processing system 306b may provide the decoded data and the decoded control information (such as to a controller/processor of the processing system 306b, an AP, first network entity 300, or another entity).

In various aspects, a wireless communication device, such as first network entity 300, second network entity 302, BS 102, UE 104, or UE 304 may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). An AI processor may perform AI processing. The AI processor may include AI accelerator hardware or circuitry such as one or more neural processing units (NPUs), one or more neural network processors, one or more tensor processors, one or more deep learning processors, etc. As an example, the AI processor may perform AI-based beam management, AI-based channel state feedback (CSF), AI-based antenna tuning, and/or AI-based positioning (e.g., non-line of sight positioning prediction). In some cases, at the UE 104, the AI processor may process feedback generated by the UE 304 (e.g., CSF) using hardware accelerated AI inferences and/or AI training. In some cases, at the second network entity 302, the AI processor may decode compressed CSF from the UE 304, for example, using a hardware accelerated AI inference associated with the CSF. In certain cases, the AI processor may perform certain RAN-based functions including, for example, network planning, network performance management, energy-efficient network operations, etc.

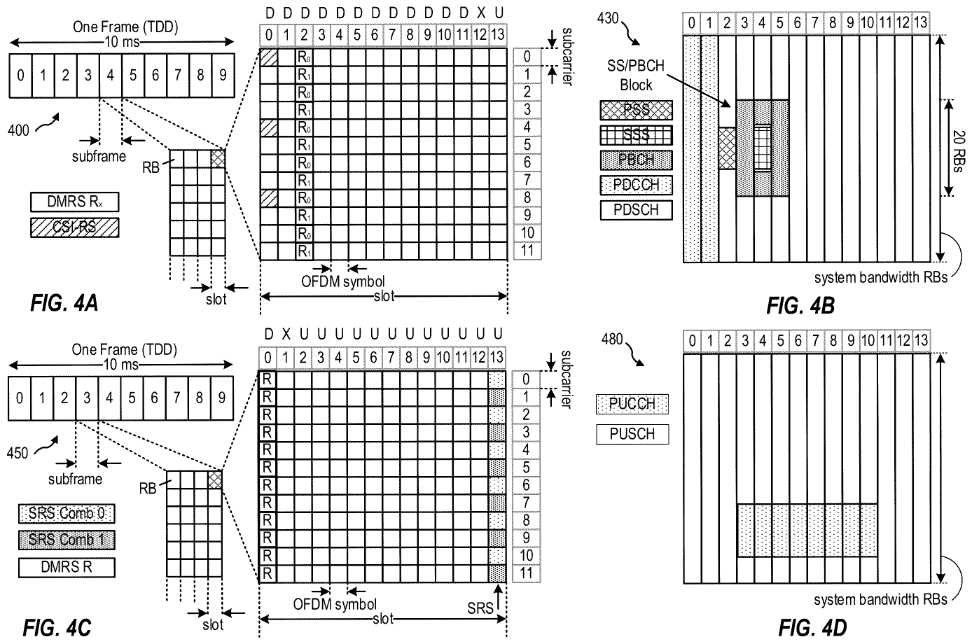

FIGS. 4A, 4B, 4C, and 4D depict aspects of data structures for a wireless communications network, such as wireless communications network 100 of FIG. 1.

FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. One or more subcarriers may be modulated with data. Modulation symbols may be sent in the frequency domain with OFDM and/or in the time domain with SC-FDM.

In some examples, a wireless communications frame structure may be implemented using frequency division duplexing (FDD). In FDD, some subcarriers may be configured for DL communication, and other subcarriers (which may overlap in time with the DL subcarriers) may be configured for UL communication. In some other examples, wireless communications frame structures may be implemented using time division duplexing (TDD). In TDD, for a particular set of subcarriers, some subframes are configured for DL communication and other subframes are configured for UL communication.

In FIGS. 4A and 4C, the wireless communications frame structure is implemented using TDD. “D” indicates DL time resources, “U” indicates UL time resources, and “X” indicates flexible time resources for use or later reconfiguration for either DL or UL communication. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology. A numerology may define a frequency domain subcarrier spacing and symbol duration, and may be configured for a given bandwidth part, carrier, cell, or network entity. In certain aspects, given a numerology μ, there are 2^{μ} slots per subframe. Thus, numerologies (μ) 0 to 6 may allow for 1, 2, 4, 8, 16, 32, and 64 slots, respectively, per subframe. In some cases, an extended CP (e.g., 12 symbols per slot) may be used with a specific numerology, such as numerology μ=2 allowing for 4 slots per subframe. The subcarrier spacing and symbol length/duration are a function of the numerology. The subcarrier spacing may be equal to 2^{μ}×15 kHz. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as a physical RB (PRB)) that extends across, for example, 12 consecutive subcarriers. The resource grid is divided into multiple resource elements (REs). An RE may include a single subcarrier in the frequency domain and a single symbol in the time domain. The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (shown as “RS”) for a UE (e.g., UE 104 of FIGS. 1 and 3). The RS may include a demodulation RS (DMRS) and/or a channel state information reference signals (CSI-RS) for channel estimation at the UE. The RS may additionally or alternatively include a beam measurement RS (BRS), a beam refinement RS (BRRS), and/or a phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as “R” for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

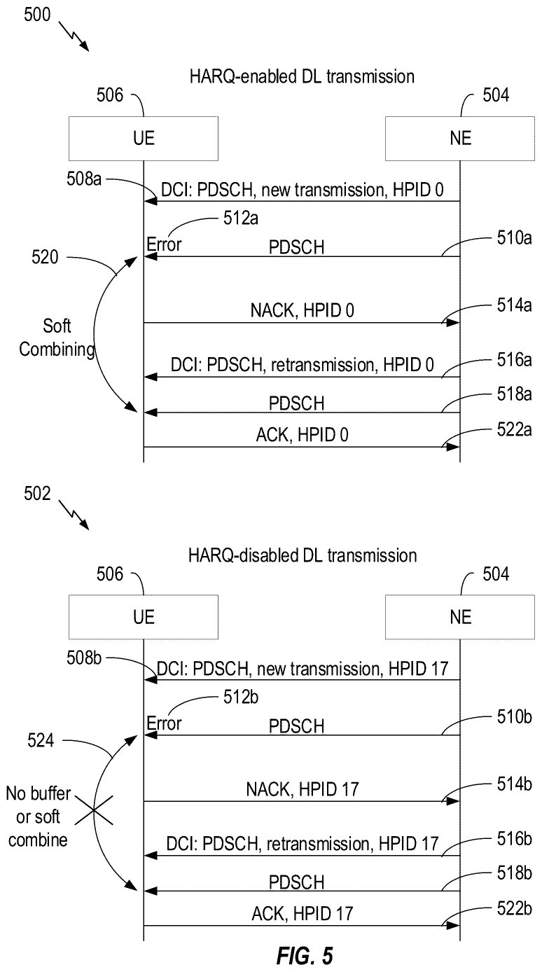

FIG. 5 provides an example 500 of HARQ-enabled downlink transmission and an example 502 of HARQ-disabled downlink transmission. FIG. 5 includes a network entity 504 and a UE 506. In some aspects, the network entity 504 may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE 506 may be an example of UE 104 depicted and described with respect to FIG. 1 or the UE 304 depicted and described with respect to FIG. 3. However, in other aspects, UE 506 may be another type of wireless communications device and network entity 504 may be another type of network entity or network node, such as those described herein.

As shown in example 500, at 508a, the network entity 504 may transmit, and the UE 506 may receive, DCI. The DCI may schedule a PDSCH. The DCI also may indicate that the scheduled PDSCH carries a new transmission (such as using a first value of an NDI field). The DCI also may indicate that the scheduled PDSCH is associated with a HARQ process ID (HPID) of 0.

The PDSCH of example 500 may be scheduled on a HARQ-enabled resource. For example, the PDSCH may be associated with a HARQ process ID that is for HARQ-enabled operation. As another example, the DCI may include an identifier (e.g., a CRC scrambled with a C-RNTI) that indicates that the PDSCH of example 500 is for HARQ-enabled operation according to aspects described herein. Thus, a HARQ-enabled resource may be a resource on which a HARQ-enabled communication is scheduled. A HARQ-enabled communication is a communication for which the UE 506 will buffer information (such as an LLR or other data) and attempt soft combination of a retransmission of the HARQ-enabled communication using the buffered information, as described below.

At 510a, the network entity 504 may transmit, and the UE 506 may receive, the PDSCH. At 512a, the UE 506 encounters an error in decoding or demodulating the PDSCH. Thus, at 514a, the UE 506 transmits a HARQ-ACK indicating a NACK for the PDSCH (such as a NACK associated with HPID 0). The UE 506 may also store (e.g., buffer) information (e.g., an LLR or other data) of the PDSCH for later soft combination.

At 516a, the network entity 504 may transmit, and the UE 506 may receive, DCI that schedules a retransmission of the PDSCH. For example, the DCI may indicate that the scheduled PDSCH carries a retransmission (such as using a second value of the NDI field) associated with the HPID 0. In some aspects, the DCI may include an RVID that indicates a redundancy version of the retransmission (which may be the same as a redundancy version of the initial transmission in the PDSCH at 510a or may be different than the redundancy version of the initial transmission).

At 518a, the network entity 504 may transmit, and the UE 506 may receive, the PDSCH carrying the retransmission. At 520, the UE 506 may perform soft combining of the buffered information from the PDSCH at 510a and information received or derived from the PDSCH at 518a. For example, the UE 506 may perform soft combining of an LLR derived from the PDSCH at 510a and an LLR derived from the PDSCH at 518a. Thus, the UE 506 may successfully decode and/or demodulate the communication on the PDSCHs. At 522a, the UE 506 transmits a HARQ-ACK carrying an ACK for the HPID 0, indicating that the communication on the PDSCHs was successfully decoded.

Example 502 is an example of HARQ-disabled downlink transmission. In example 502, at 524, the UE 506 does not perform buffering of information associated with failed reception of a PDSCH. The UE 506 also does not perform soft combining for the PDSCH since no data from the original PDSCH is stored or buffered.

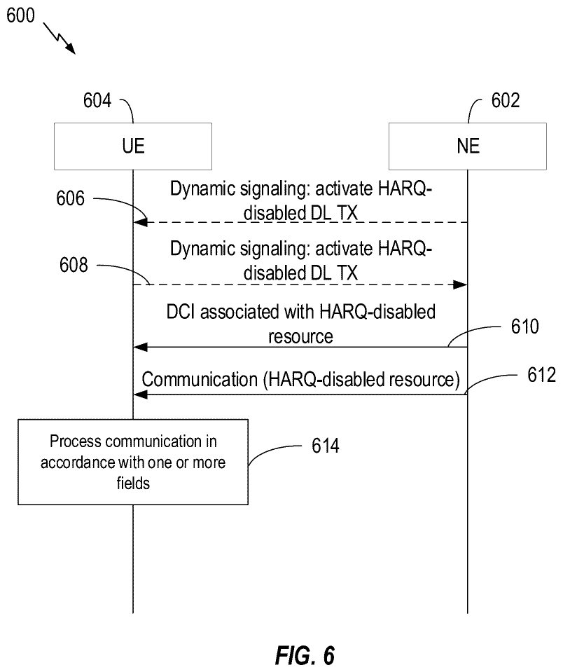

As shown in example 502, at 508b, the network entity 504 may transmit, and the UE 506 may receive, DCI. The DCI may schedule a PDSCH. The DCI also may indicate that the scheduled PDSCH is associated with an HPID of 17. In some aspects, the HPID of 17 may be associated with a second set of HARQ process IDs, such as HARQ process IDs associated with a HARQ-disabled configuration. In some aspects, an NDI field, RVID field, MCS field, or the like, of the DCI may be based on the DCI being associated with a HARQ-disabled downlink transmission, as described in connection with FIG. 6.

The PDSCH of example 502 may be scheduled on a HARQ-enabled resource. For example, the PDSCH may be associated with a HARQ process ID that is for HARQ-disabled operation. As another example, the DCI may include an identifier (e.g., a CRC scrambled with a CS-RNTI) that indicates that the PDSCH of example 502 is for HARQ-disabled operation. Thus, a HARQ-disabled resource may be a resource on which a HARQ-disabled communication is scheduled. A HARQ-disabled communication is a communication for which the UE 506 will not buffer information (such as an LLR or other data) and will not attempt soft combination of a retransmission of the HARQ-disabled communication using the buffered information, as described below.

At 510b, the network entity 504 may transmit, and the UE 506 may receive, the PDSCH. At 512b, the UE 506 encounters an error in decoding or demodulating the PDSCH. Thus, at 514b, the UE 506 transmits a HARQ-ACK indicating a NACK for the PDSCH (such as a NACK associated with HPID 17). In example 502, since the PDSCH is on a HARQ-disabled resource or is associated with HARQ-disabled operation, the UE 506 does not store (e.g., buffer) information (e.g., an LLR or other data) of the PDSCH for later soft combination.

At 516b, the network entity 504 may transmit, and the UE 506 may receive, DCI that schedules a retransmission of the PDSCH. The DCI may or may not indicate that the scheduled PDSCH carries a retransmission (such as using a second value of the NDI field) associated with the HPID 17, as described below. The DCI may or may not include an RVID that indicates a redundancy version of the retransmission, as also described below.

At 518b, the network entity 504 may transmit, and the UE 506 may receive, the PDSCH carrying the retransmission. As noted at 524, the UE 506 does not perform soft combining of the buffered information from the PDSCH at 510b and information received or derived from the PDSCH at 518b. Thus, resource usage and memory usage at the UE 506 is reduced. At 522b, the UE 506 transmits a HARQ-ACK carrying an ACK for the HPID 17, indicating that the communication on the PDSCHs was successfully decoded.

FIG. 6 is a diagram illustrating an example 600 of signaling associated with interpretation of DCI fields for HARQ-disabled downlink transmission. FIG. 6 includes a network entity 602 and a UE 604. In some aspects, the network entity 602 may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE 604 may be an example of UE 104 depicted and described with respect to FIG. 1 or the UE 304 depicted and described with respect to FIG. 3. However, in other aspects, UE 604 may be another type of wireless communications device and network entity 602 may be another type of network entity or network node, such as those described herein.

Example 600 is described with regard to a plurality of HARQ process IDs. In some aspects, the plurality of HARQ process IDs may include a first set of HARQ process IDs and a second set of HARQ process IDs. The first set of HARQ process IDs may be associated with a HARQ-enabled configuration, such that the UE 604 buffers data associated with a failed reception of a PDSCH associated with one of the first set of HARQ process IDs. In some aspects, the second set of HARQ process IDs may be associated with a HARQ-disabled configuration, such that the UE 604 does not buffer data associated with a failed reception of a PDSCH associated with one of the second set of HARQ process IDs. In some other aspects, the HARQ-disabled configuration may be activated for one or more HARQ process IDs of the second set of HARQ process IDs. For example, the UE 604 may treat the second set of HARQ process IDs as HARQ-enabled until the UE 604 receives or transmits an activation of the HARQ-disabled configuration for one or more of the second set of HARQ process IDs, as described with regard to 606 and 608 below.

As shown in FIG. 6, at 606, the network entity 602 may optionally transmit, and the UE 604 may receive, dynamic signaling that activates HARQ-disabled downlink transmission. For example, a downlink serving cell (e.g., a cell that schedules a PDSCH via the DCI at 610) may transmit the dynamic signaling. The dynamic signaling may indicate one or more HARQ process IDs for which a HARQ-disabled configuration is activated. For example, the dynamic signaling may indicate that the UE 604 is not to store (e.g., buffer) information such as an LLR for an erroneously-received PUSCH associated with one of the one or more HARQ process IDs. In some aspects, the dynamic signaling may indicate a HARQ-disabled configuration for a resource. For example, the dynamic signaling may indicate a HARQ-disabled configuration for a HARQ process ID associated with a resource (e.g., a HARQ process ID associated with a PDSCH scheduled on the resource) and may thereby indicate a HARQ-disabled configuration for the resource. As used herein, “HARQ-disabled resource” may refer to a resource on which a communication is scheduled, where the communication is associated with a HARQ-disabled configuration (e.g., a HARQ process ID for which soft combining and/or buffering is disabled).

In some aspects, this dynamic signaling at 606 may be applicable for the second set of HARQ process IDs described above (e.g., and not for the first set of HARQ process IDs, which include HARQ process IDs that are HARQ-enabled). For example, the dynamic signaling at 606 may indicate only one or more HARQ process ID of the second set of HARQ process IDs. The dynamic signaling at 606 may include MAC signaling (such as a MAC control element (MAC-CE)), DCI, or the like. In some aspects, the dynamic signaling at 606 may comprise the DCI at 610.

As shown, at 608, the UE 604 may optionally transmit, and the network entity 602 may receive, uplink control information that indicates a HARQ-disabled resource. For example, the uplink control information may indicate one or more HARQ process IDs for which a HARQ-disabled configuration is activated. As another example, the uplink control information may include a HARQ-ACK indicating a NACK for a communication, and the HARQ-ACK may include or be associated with an indication that the HARQ disabled configuration is activated for a HARQ process ID associated with the HARQ-ACK (e.g., may indicate that the UE 604 discarded the communication associated with the HARQ-ACK). This may be useful, for example, when memory usage (e.g., double data rate memory usage) at the UE 604 exceeds a threshold, since the UE 604 can stop storing data associated with failed receptions and indicate this to the network entity 602. In some aspects, the uplink control information at 608 may be applicable for the second set of HARQ process IDs described above (e.g., and not for the first set of HARQ process IDs, which include HARQ process IDs that are HARQ-enabled). For example, the uplink control information may indicate only one or more HARQ process IDs of the second set of HARQ process IDs.

At 610, the network entity 602 may transmit, and the UE 604 may receive, DCI associated with a HARQ-disabled resource. The DCI may be associated with the HARQ-disabled resource in that the DCI schedules a communication associated with a HARQ process ID with a HARQ-disabled configuration, and the communication is on the resource referred to as a HARQ-disabled resource. The DCI may indicate a HARQ process ID for the communication. The HARQ process ID may be associated with a HARQ-disabled configuration, such that the UE 604 does not store information associated with the communication if reception of the communication fails. The DCI may include one or more fields. The one or more fields may include an NDI field, an RVID field, or a combination thereof. The UE 604 interprets the one or more fields based on the DCI being associated with the HARQ-disabled resource, as described with respect to the processing of the communication at 614.

At 612, the network entity 602 transmits, and the UE 604 receives, a communication on the HARQ-disabled resource. For example, the network entity 602 may transmit the communication in accordance with the one or more fields. At 614, the UE 604 processes the communication on the HARQ-disabled resource in accordance with the one or more fields. For example, the UE 604 may process the communication in accordance with one or more fields of the DCI, wherein the one or more fields are interpreted by the UE 604 based on the DCI being associated with the HARQ-disabled resource. That is, the UE 604 may use a first interpretation or configuration of fields of the DCI when the DCI schedules a communication on a HARQ-disabled resource, and may use a second interpretation or configuration of fields of the DCI when the DCI schedules a communication on a HARQ-enabled resource.

In some aspects, the one or more fields may include an NDI field and an RVID field. To process the communication in accordance with the one or more fields based on the DCI being associated with the HARQ-disabled resource, the UE 604 may ignore the one or more fields. For example, the 604 may assume a default redundancy version (e.g., with an RVID of 0) and may make no assumption on NDI (e.g., may process the communication without regard for whether the communication is an initial transmission or a retransmission). If the DCI instead scheduled a communication on a HARQ-enabled resource, the UE 604 may process the communication by combining the communication with another communication in accordance with whether the communication is an initial transmission or a retransmission (in accordance with the NDI) and identifying parity bits or a rate matching pattern of the communication (in accordance with the RVID).

In some aspects, the one or more fields may include a field that jointly indicates an RVID and/or NDI for one or more HARQ-enabled resources (e.g., one or more HARQ-enabled HARQ process IDs associated with communications on one or more first resources) and one or more HARQ process IDs for one or more HARQ-disabled resources (e.g., one or more HARQ-disabled HARQ process IDs associated with communications on one or more second resources). This may reduce overhead relative to indicating the RVID, NDI, and HARQ-disabled HARQ process IDs separately. For example, if 16 HARQ process IDs are HARQ-enabled and 48 HARQ process IDs are HARQ-disabled, instead of 6+1+2=9 bits in the DCI to indicate HARQ process ID, NDI, and RVID fields, the single field may use ceil(log 2(16*2*4+48))=8 bits. The UE 604 may process the communication according to the HARQ process ID of the single field.

In some aspects, DCI associated with a HARQ-disabled resource (e.g., indicating a HARQ-disabled HARQ process ID for a communication on a resource) may have a repurposed NDI and/or RVID field. For example, the DCI may not include an NDI and/or RVID field, and bits of these fields may be used for other purposes. For example, when scheduling a PDSCH, the DCI may include one or more bits that indicate an MCS, a frequency-domain resource allocation (FDRA), or a time-domain resource allocation (TDRA) at a higher granularity than DCI that includes an NDI field and an RVID field. As another example, for a PUCCH, the DCI may include one or more bits that indicate a transmit power control (TPC) command at a higher granularity than DCI that includes an NDI field and an RVID field. The UE 604 may process the communication according to the MCS, the FDRA, or the TDRA, or may transmit a PUCCH (such as a HARQ-ACK) in accordance with the TPC command. If the DCI instead scheduled a communication on a HARQ-enabled resource, the UE 604 may interpret the bits of these fields as an NDI field and an RVID field, as described above.

In some aspects, the communication at 614 may be a retransmission of an initial communication. For example, the DCI at 610 may schedule the communication as the retransmission of the initial communication. In some aspects, the DCI may indicate a reserved MCS (e.g., an MCS index of 28, 29, 30, or 31), which indicates a modulation scheme and to assume a same code rate as the initial communication for the communication. For example, retransmission of a PDSCH communication with a HARQ-disabled HARQ process ID (that is, on a HARQ-disabled resource) with a reserved MCS may be allowed. In this case, the DCI may include an NDI field, and the NDI field may indicate that the communication is a retransmission. In some examples, processing the communication may include processing the communication according to a modulation scheme indicated by the reserved MCS and a code rate of the initial communication.

In some aspects, the DCI may not be permitted to indicate a reserved MCS for a retransmission on a HARQ-disabled resource. For example, DCI associated with a HARQ-disabled resource (e.g., indicating a HARQ-disabled HARQ process ID for a communication on a resource), such as DCI with a HARQ process ID from the second set off HARQ process IDs, may be restricted to indicate only non-reserved MCS values (e.g., MCS indexes of 0 through 27). In some examples, processing the communication may include processing the communication according to a modulation scheme and code rate indicated by the non-reserved MCS value (e.g., a non-reserved code rate). Thus, the DCI may be configured to indicate only non-reserved code rates based on the HARQ-disabled resource being associated with no reserved MCS. DCI that schedules a retransmission on a HARQ-enabled resource may be permitted to indicate a reserved MCS for the retransmission.

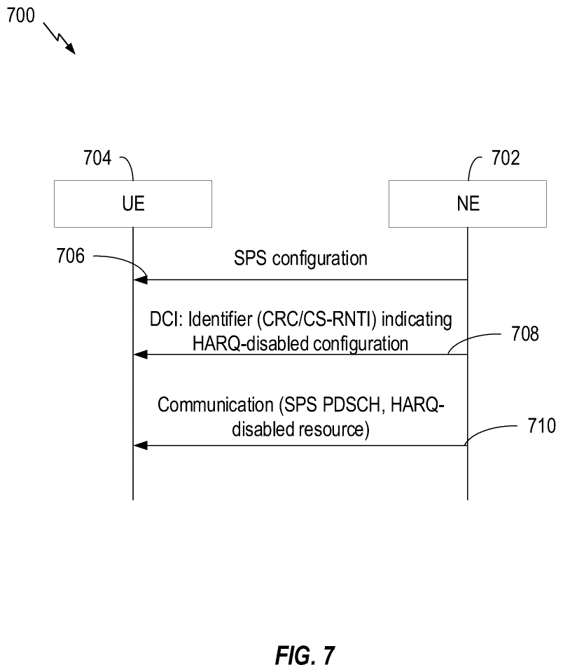

FIG. 7 is a diagram illustrating an example 700 of indication of a HARQ-disabled configuration associated with an SPS configuration. FIG. 7 includes a network entity 702 and a UE 704. In some aspects, the network entity 702 may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE 704 may be an example of UE 104 depicted and described with respect to FIG. 1 or the UE 304 depicted and described with respect to FIG. 3. However, in other aspects, UE 704 may be another type of wireless communications device and network entity 702 may be another type of network entity or network node, such as those described herein.

As shown, at 706, the network entity 702 may transmit, and the UE 704 may receive, an SPS configuration. The SPS configuration may indicate a resource allocation for an SPS PDSCH, a periodicity of the SPS PDSCH, a trigger condition (in this case, reception of a DCI), and a set of HARQ process IDs associated with the SPS PDSCH.

In example 700, HARQ-disabled configuration may be configured as part of the SPS configuration, rather than specific to a HARQ process ID. For example, the set of HARQ process IDs indicated by the SPS configuration may be usable for HARQ-enabled downlink communication or HARQ-disabled downlink communication, based on whether a communication associated with one of these HARQ process IDs is indicated as associated with a HARQ-enabled configuration or a HARQ-disabled configuration.

At 708, the network entity 702 may transmit, and the UE 704 may receive, DCI. The DCI may trigger activation of the SPS configuration. Furthermore, the DCI may indicate a HARQ-disabled configuration for a HARQ process ID indicated by the SPS configuration. For example, the DCI may include an identifier. The identifier may include, for example, a CRC scrambled with an RNTI, such as a C-RNTI or a CS-RNTI. If the CRC is scrambled with the CS-RNTI, then the DCI (and the identifier) may be associated with the SPS configuration (e.g., may trigger activation of the SPS configuration). Alternatively, if the CRC is scrambled with the C-RNTI, then the DCI may dynamically schedule a communication.

At 710, the network entity 702 may transmit, and the UE 704 may receive, a communication on an SPS PDSCH indicated by the SPS configuration. The communication may be associated with the HARQ process ID indicated by the DCI. If the identifier is associated with the SPS configuration (e.g., is scrambled with the CS-RNTI), then the UE 704 may process the communication using a HARQ-disabled configuration. For example, if reception (e.g., decoding or demodulation) of the communication fails, the UE 704 may not buffer data associated with the communication. Thus, the HARQ process ID may be indicated as associated with a HARQ-disabled configuration by providing DCI that is scrambled with a CS-RNTI (e.g., associated with an SPS configuration). Thus, HARQ-disabled functionality may be configured as part of an SPS configuration, rather than per HARQ process ID. If the identifier is scrambled using a C-RNTI, then the UE 704 may process the communication (which may be dynamically scheduled by the DCI instead of on an SPS PDSCH indicated by the SPS configuration) using a HARQ-enabled configuration. For example, if reception (e.g., decoding or demodulation) of the communication fails, the UE 704 may buffer data associated with the communication. Thus, a given HARQ process ID may be HARQ-enabled for the C-RNTI, and can be HARQ-disabled for CS-RNTI/SPS (given that there is no re-transmission between C-RNTI and CS-RNTI). This is beneficial for cases wherein the network entity 702 does not want to retransmit an SPS PDSCH to facilitate soft combining, since the missed communication can be retransmitted on a later SPS PDSCH (due to the SPS PDSCH's periodic nature and tendency to carry low-latency traffic), and for cases where the network entity 702 does not want the dynamic grant PDSCHs to be HARQ-disabled when the same HARQ process ID is used for the dynamic grant PDSCHs and the SPS PDSCH.

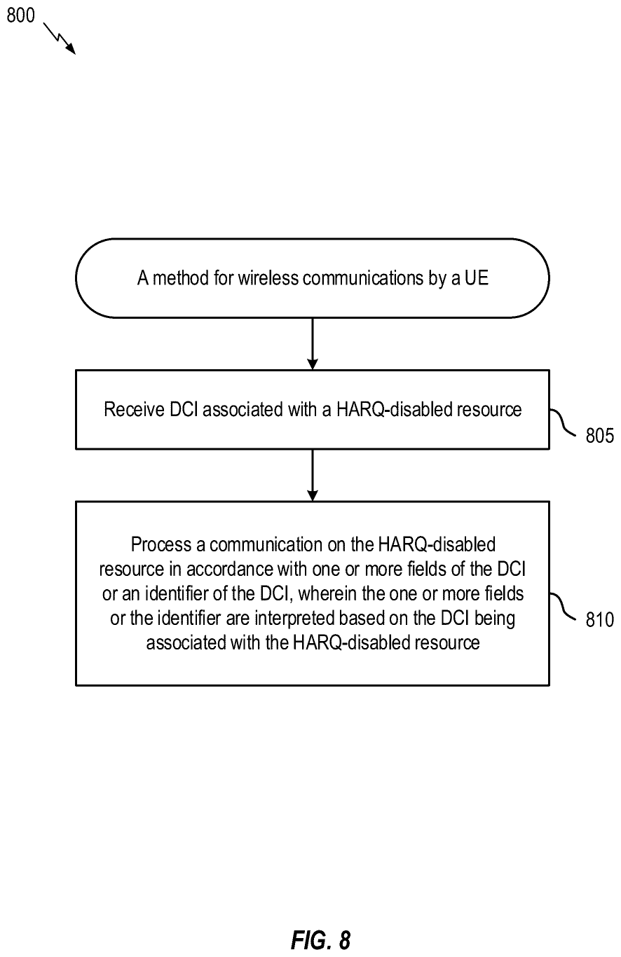

FIG. 8 shows a method 800 for wireless communications by an apparatus, such as UE 104 of FIG. 1 or UE 304 of FIG. 3.

Method 800 begins at block 805 with receiving DCI associated with a HARQ-disabled resource, as shown at 610 and 708.

Method 800 then proceeds to block 810 with processing a communication (as shown at 614 and 710) on the HARQ-disabled resource in accordance with one or more fields of the DCI (as described with regard to FIG. 6) or an identifier (as described with regard to FIG. 7) of the DCI, wherein the one or more fields or the identifier are interpreted (as shown at 612) based on the DCI being associated with the HARQ-disabled resource.

In some aspects, the one or more fields comprise an NDI field, wherein block 810 includes processing the communication without an assumption regarding the NDI field.

In some aspects, the one or more fields comprise a RVID field, wherein block 810 includes processing the communication using a default RVID.

In some aspects, the one or more fields comprise a single field that jointly indicates: a redundancy version identifier and a new data indicator for a HARQ-enabled resource, and a HARQ process identifier for the HARQ-disabled resource.

In some aspects, the one or more fields comprise at least one of an NDI field or a RVID field, wherein, in association with the DCI being associated with the HARQ-disabled resource, the one or more fields indicate at least one of: a modulation and coding scheme, a resource allocation, or a transmit power control command.

In some aspects, the one or more fields comprise an NDI field based on the HARQ-disabled resource being associated with a reserved modulation and coding scheme, wherein block 810 includes processing the communication using an NDI indicated by the NDI field.

In some aspects, the HARQ-disabled resource is associated with no reserved modulation and coding scheme, and wherein the DCI is configured to indicate only non-reserved code rates based on the HARQ-disabled resource being associated with no reserved modulation and coding scheme.

In some aspects, method 800 further includes transmitting, prior to receiving the DCI, uplink control information that indicates a HARQ-disabled configuration for the HARQ-disabled resource.

In some aspects, the uplink control information is associated with a HARQ acknowledgment for the prior communication.

In some aspects, method 800 further includes receiving, prior to the DCI, dynamic signaling that indicates a HARQ-disabled configuration for the HARQ-disabled resource.

In some aspects, method 800 further includes receiving a SPS configuration that indicates the HARQ-disabled resource, wherein block 810 includes processing the communication using a HARQ-disabled configuration in accordance with the identifier being associated with the SPS configuration.

In some aspects, method 800 further includes receiving second DCI associated with a same HARQ process identifier as the first DCI.

In some aspects, method 800 further includes processing a second communication scheduled by the second DCI using a HARQ-enabled configuration in accordance with a second identifier of the second DCI being associated with dynamic scheduling.

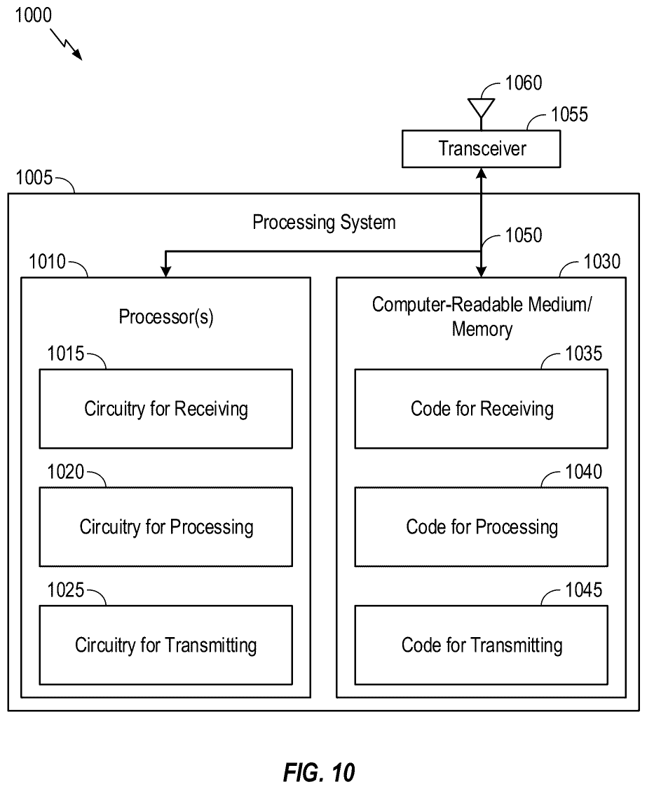

In some aspects, method 800, or any aspect related to it, may be performed by an apparatus, such as communications device 1000 of FIG. 10, which includes various components operable, configured, or adapted to perform the method 800. Communications device 1000 is described below in further detail.

Note that FIG. 8 is just one example of a method, and other methods including fewer, additional, or alternative operations are possible consistent with this disclosure.

### Example Operations of a Network Entity

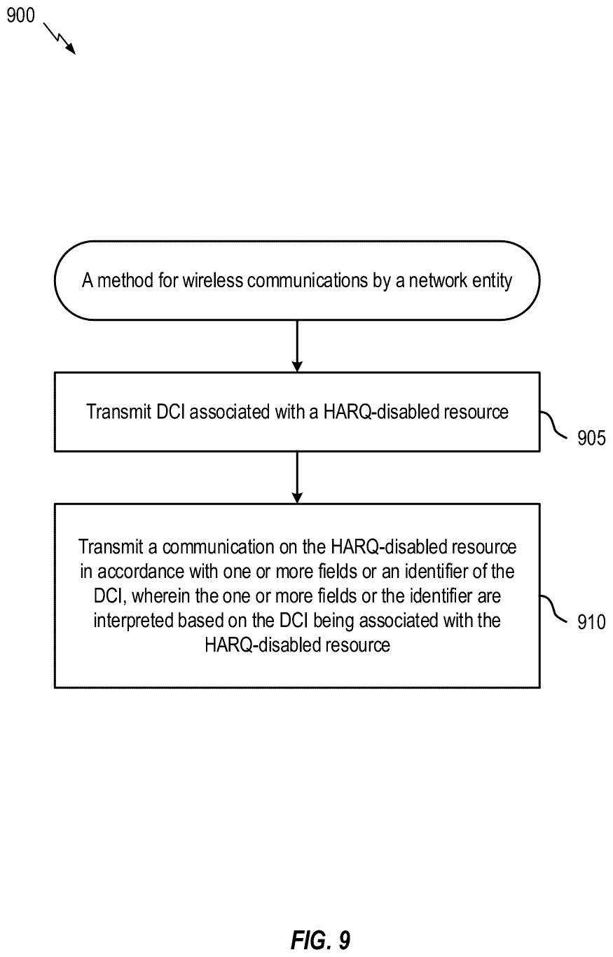

FIG. 9 shows a method 900 for wireless communications by an apparatus, such as BS 102 of FIG. 1, a first network entity 300 or second network entity 302 of FIG.
3, or a disaggregated base station as discussed with respect to FIG. 2.

Method 900 begins at block 905 with transmitting DCI associated with a HARQ-disabled resource, as shown at 610 and 708.

Method 900 then proceeds to block 910 with transmitting a communication (as shown at 614 and 710) on the HARQ-disabled resource in accordance with one or more fields of the DCI (as described with regard to FIG. 6) or an identifier (as described with regard to FIG. 7) of the DCI, wherein the one or more fields or the identifier are interpreted (as shown at 612) based on the DCI being associated with the HARQ-disabled resource.

In some aspects, the one or more fields comprise a RVID field, wherein block 910 includes transmitting the communication using a default RVID.

In some aspects, the one or more fields comprise a single field that jointly indicates: a redundancy version identifier and a new data indicator for a HARQ-enabled resource, and a HARQ process identifier for the HARQ-disabled resource.

In some aspects, the one or more fields comprise at least one of an NDI field or a RVID field, wherein, in association with the DCI being associated with the HARQ-disabled resource, the one or more fields indicate at least one of: a modulation and coding scheme, a resource allocation, or a transmit power control command.

In some aspects, the HARQ-disabled resource is associated with no reserved modulation and coding scheme, and wherein the DCI is configured to indicate only non-reserved code rates based on the HARQ-disabled resource being associated with no reserved modulation and coding scheme.

In certain aspects, method 900 further includes receiving, prior to receiving the DCI, uplink control information that indicates a HARQ-disabled configuration for the HARQ-disabled resource.

In some aspects, the uplink control information is associated with a HARQ acknowledgment for the prior communication.

In certain aspects, method 900 further includes transmitting, prior to the DCI, dynamic signaling that indicates a HARQ-disabled configuration for the HARQ-disabled resource.

In certain aspects, method 900 further includes transmitting a SPS configuration that indicates the HARQ-disabled resource, wherein block 910 includes transmitting the communication using a HARQ-disabled configuration in accordance with the identifier being associated with the SPS configuration.

In certain aspects, method 900 further includes transmitting second DCI associated with a same HARQ process identifier as the first DCI.

In certain aspects, method 900 further includes transmitting a second communication scheduled by the second DCI using a HARQ-enabled configuration in accordance with a second identifier of the second DCI being associated with dynamic scheduling.

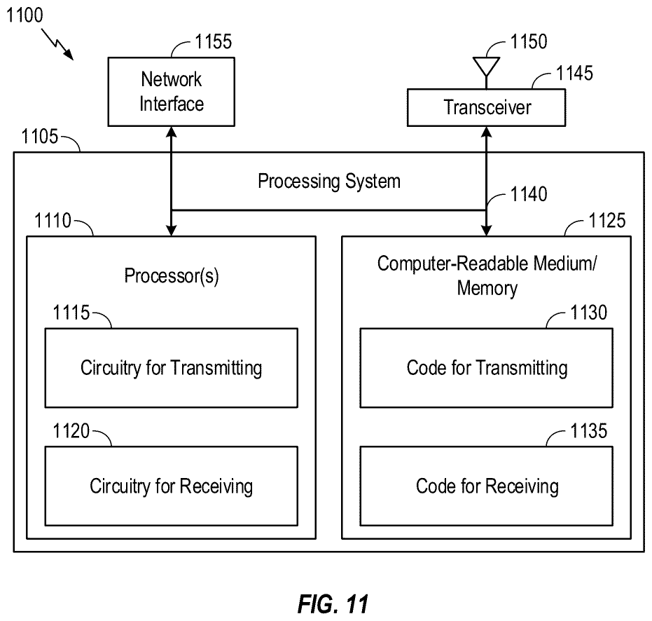

In some aspects, method 900, or any aspect related to it, may be performed by an apparatus, such as communications device 1100 of FIG. 11, which includes various components operable, configured, or adapted to perform the method 900. Communications device 1100 is described below in further detail.

Note that FIG. 9 is just one example of a method, and other methods including fewer, additional, or alternative operations are possible consistent with this disclosure.

### Example Communications Devices

FIG. 10 depicts aspects of an example communications device 1000 configured for wireless communications. In some aspects, communications device 1000 is a user equipment, such as UE 104 described above with respect to FIG. 1 or UE 304 described with respect to FIG. 3.

The communications device 1000 includes a processing system 1005 coupled to a transceiver 1055 (e.g., a transmitter and/or a receiver). The transceiver 1055 is configured to transmit and receive signals for the communications device 1000 via an antenna 1060, such as the various signals as described herein. The processing system 1005 may be configured to perform processing functions for the communications device 1000, including processing signals received and/or to be transmitted by the communications device 1000.

The processing system 1005 includes one or more processors 1010 and a computer-readable medium/memory 1030. In various aspects, the one or more processors 1010 may be representative of the one or more processors 318 described with respect to FIG. 3. The one or more processors 1010 are coupled to a computer-readable medium/memory 1030 via a bus 1050. In some aspects, the computer-readable medium/memory 1030 may be representative of the one or more memories 320 described with respect to FIG. 3. The computer-readable medium/memory 1030 is a non-transitory computer-readable medium/memory. In certain aspects, the computer-readable medium/memory 1030 is configured to store instructions (e.g., computer-executable code), that when executed by the one or more processors 1010, cause the one or more processors 1010 to perform the method 800 described with respect to FIG. 8, or any aspect related to it, including any operations described in relation to FIG. 8. Note that reference to a processor performing a function of communications device 1000 may include one or more processors performing that function of communications device 1000, such as in a distributed fashion.

In the depicted example, computer-readable medium/memory 1030 stores code (e.g., executable instructions), including code for receiving 1035, code for processing 1040, and code for transmitting 1045. Processing of the code 1035-1045 may enable and cause the communications device 1000 to perform the method 800 described with respect to FIG. 8, or any aspect related to it. For example, in some aspects, code for receiving 1035 may include code for receiving DCI associated with a HARQ-disabled resource. In some aspects, code for processing 1040 may include code for processing a communication on the HARQ-disabled resource in accordance with one or more fields of the DCI or an identifier of the DCI, wherein the one or more fields or the identifier are interpreted based on the DCI being associated with the HARQ-disabled resource.

The one or more processors 1010 include circuitry configured to implement (e.g., execute) the code stored in the computer-readable medium/memory 1030, including circuitry for receiving 1015, circuitry for processing 1020, and circuitry for transmitting 1025. Processing with circuitry 1015-1025 may enable and cause the communications device 1000 to perform the method 800 described with respect to FIG. 8, or any aspect related to it. For example, in some aspects, circuitry for receiving 1015 may include circuitry for receiving DCI associated with a HARQ-disabled resource. In some aspects, circuitry for processing 1020 may include circuitry for processing a communication on the HARQ-disabled resource in accordance with one or more fields of the DCI or an identifier of the DCI, wherein the one or more fields or the identifier are interpreted based on the DCI being associated with the HARQ-disabled resource.

More generally, means for communicating, transmitting, sending or outputting for transmission may include the one or more transceivers 324, one or more antenna 322 and/or processing system 316 of the UE 304 illustrated in FIG. 3, transceiver 1055 and/or antenna 1060 of the communications device 1000 in FIG. 10, and/or one or more processors 1010 of the communications device 1000 in FIG. 10. Means for communicating, receiving or obtaining may include the one or more transceivers 324, one or more antennas 322, and/or processing system 316 of the UE 304 illustrated in FIG. 3, transceiver 1055 and/or antenna 1060 of the communications device 1000 in FIG. 10, and/or one or more processors 1010 of the communications device 1000 in FIG. 10.

FIG. 11 depicts aspects of an example communications device configured for wireless communications. In some aspects, communications device 1100 is a network entity, such as BS 102 of FIG. 1, first network entity 300 or second network entity 302 of FIG. 3, or a disaggregated base station as discussed with respect to FIG. 2.

The communications device 1100 includes a processing system 1105 coupled to a transceiver 1145 (e.g., a transmitter and/or a receiver) and/or a network interface 1155. The transceiver 1145 is configured to transmit and receive signals for the communications device 1100 via an antenna 1150, such as the various signals as described herein. The network interface 1155 is configured to obtain and send signals for the communications device 1100 via communications link(s), such as a backhaul link, midhaul link, and/or fronthaul link as described herein, such as with respect to FIG. 2. The processing system 1105 may be configured to perform processing functions for the communications device 1100, including processing signals received and/or to be transmitted by the communications device 1100.

The processing system 1105 includes one or more processors 1110 and a computer-readable medium/memory 1125. In various aspects, one or more processors 1110 may be representative of the one or more processors 308, as described with respect to FIG. 3. The one or more processors 1110 are coupled to the computer-readable medium/memory 1125 via a bus 1140. In certain aspects, the computer-readable medium/memory 1125 is configured to store instructions (e.g., computer-executable code), including code 1130 and 1135, that when executed by the one or more processors 1110, cause the one or more processors 1110 to perform the method 900 described with respect to FIG. 9, or any aspect related to it, including any operations described in relation to FIG. 9. The computer-readable medium/memory 1125 is a non-transitory computer-readable medium/memory. Note that reference to a processor of communications device 1100 performing a function may include one or more processors of communications device 1100 performing that function, such as in a distributed fashion.

In the depicted example, the computer-readable medium/memory 1125 stores code (e.g., executable instructions), including code for transmitting 1130 and code for receiving 1135. Processing of the code 1130 and 1135 may enable and cause the communications device 1100 to perform the method 900 described with respect to FIG. 9, or any aspect related to it. For example, in some aspects, code for transmitting 1130 may include code for transmitting DCI associated with a HARQ-disabled resource. In some aspects, code for transmitting 1130 may include code for transmitting a communication on the HARQ-disabled resource in accordance with one or more fields of the DCI or an identifier of the DCI, wherein the one or more fields or the identifier are interpreted based on the DCI being associated with the HARQ-disabled resource.

The one or more processors 1110 include circuitry configured to implement (e.g., execute) the code stored in the computer-readable medium/memory 1125, including circuitry for transmitting 1115 and circuitry for receiving 1120. Processing with circuitry 1115 and 1120 may enable and cause the communications device 1100 to perform the method 900 described with respect to FIG. 9, or any aspect related to it. For example, in some aspects, circuitry for transmitting 1115 may include circuitry for transmitting DCI associated with a HARQ-disabled resource. In some aspects, circuitry for transmitting 1115 may include circuitry for transmitting a communication on the HARQ-disabled resource in accordance with one or more fields of the DCI or an identifier of the DCI, wherein the one or more fields or the identifier are interpreted based on the DCI being associated with the HARQ-disabled resource.

Various components of the communications device 1100 may provide means for performing the method 900 described with respect to FIG. 9, or any aspect related to it. Means for communicating, transmitting, sending or outputting for transmission may include the one or more transceivers 312, one or more antennas 314, and/or processing system 306 of the first network entity 300 or the second network entity 302 illustrated in FIG. 3, transceiver 1145, antenna 1150, and/or network interface 1155 of the communications device 1100 in FIG. 11, and/or one or more processors 1110 of the communications device 1100 in FIG. 11. Means for communicating, receiving or obtaining may include the one or more transceivers 312, one or more antennas 314, and/or processing system 306 of the first network entity 300 or the second network entity 302 illustrated in FIG. 3, transceiver 1145, antenna 1150, and/or network interface 1155 of the communications device 1100 in FIG. 11, and/or one or more processors 1110 of the communications device 1100 in FIG. 11.

### Example Clauses

Implementation examples are described in the following numbered clauses:

Clause 1: A method for wireless communications by a UE comprising: receiving DCI associated with a HARQ-disabled resource; and processing a communication on the HARQ-disabled resource in accordance with one or more fields of the DCI or an identifier of the DCI, wherein the one or more fields or the identifier are interpreted based on the DCI being associated with the HARQ-disabled resource.

Clause 2: The method of Clause 1, wherein the one or more fields comprise an NDI field, wherein processing the communication in accordance with the one or more fields comprises processing the communication without regard for whether the communication is an initial transmission or a retransmission.

Clause 3: The method of any one of Clauses 1-2, wherein the one or more fields comprise a RVID field, wherein processing the communication in accordance with the one or more fields comprises processing the communication using a default RVID.

Clause 4: The method of any one of Clauses 1-3, wherein the one or more fields comprise a single field that jointly indicates: a redundancy version identifier and a new data indicator for a HARQ-enabled resource, and a HARQ process identifier for the HARQ-disabled resource.

Clause 5: The method of any one of Clauses 1-4, wherein the one or more fields comprise at least one of an NDI field or a RVID field, wherein, in association with the DCI being associated with the HARQ-disabled resource, the one or more fields indicate at least one of: a modulation and coding scheme, a resource allocation, or a transmit power control command.

Clause 6: The method of any one of Clauses 1-5, wherein the one or more fields comprise an NDI field based on the HARQ-disabled resource being associated with a reserved modulation and coding scheme, wherein processing the communication in accordance with the one or more fields comprises processing the communication using an NDI indicated by the NDI field.

Clause 7: The method of any one of Clauses 1-6, wherein the HARQ-disabled resource is associated with no reserved modulation and coding scheme, and wherein the DCI is configured to indicate only non-reserved code rates based on the HARQ-disabled resource being associated with no reserved modulation and coding scheme.

Clause 8: The method of any one of Clauses 1-7, further comprising transmitting, prior to receiving the DCI, uplink control information that indicates a HARQ-disabled configuration for the HARQ-disabled resource.

Clause 9: The method of Clause 8, wherein the uplink control information is associated with a HARQ acknowledgment for the prior communication.

Clause 10: The method of any one of Clauses 1-9, further comprising receiving, prior to the DCI, dynamic signaling that indicates a HARQ-disabled configuration for the HARQ-disabled resource.

Clause 11: The method of any one of Clauses 1-10, further comprising receiving a SPS configuration that indicates the HARQ-disabled resource, wherein processing the communication in accordance with the one or more fields of the DCI or the identifier comprises processing the communication using a HARQ-disabled configuration in accordance with the identifier being associated with the SPS configuration.

Clause 12: The method of Clause 11, further comprising: receiving second DCI associated with a same HARQ process identifier as the first DCI; and processing a second communication scheduled by the second DCI using a HARQ-enabled configuration in accordance with a second identifier of the second DCI being associated with dynamic scheduling.

Clause 13: A method for wireless communications by a network entity comprising: transmitting DCI associated with a HARQ-disabled resource; and transmitting a communication on the HARQ-disabled resource in accordance with one or more fields of the DCI or an identifier of the DCI, wherein the one or more fields or the identifier are interpreted based on the DCI being associated with the HARQ-disabled resource.

Clause 14: The method of Clause 13, wherein the one or more fields comprise a RVID field, wherein transmitting the communication in accordance with the one or more fields comprises transmitting the communication using a default RVID.

Clause 15: The method of any one of Clauses 13-14, wherein the one or more fields comprise a single field that jointly indicates: a redundancy version identifier and a new data indicator for a HARQ-enabled resource, and a HARQ process identifier for the HARQ-disabled resource.

Clause 16: The method of any one of Clauses 13-15, wherein the one or more fields comprise at least one of an NDI field or a RVID field, wherein, in association with the DCI being associated with the HARQ-disabled resource, the one or more fields indicate at least one of: a modulation and coding scheme, a resource allocation, or a transmit power control command.

Clause 17: The method of any one of Clauses 13-16, wherein the HARQ-disabled resource is associated with no reserved modulation and coding scheme, and wherein the DCI is configured to indicate only non-reserved code rates based on the HARQ-disabled resource being associated with no reserved modulation and coding scheme.

Clause 18: The method of any one of Clauses 13-17, further comprising receiving, prior to receiving the DCI, uplink control information that indicates a HARQ-disabled configuration for the HARQ-disabled resource.

Clause 19: The method of Clause 18, wherein the uplink control information is associated with a HARQ acknowledgment for the prior communication.

Clause 20: The method of any one of Clauses 13-19, further comprising transmitting, prior to the DCI, dynamic signaling that indicates a HARQ-disabled configuration for the HARQ-disabled resource.

Clause 21: The method of any one of Clauses 13-20, further comprising transmitting a SPS configuration that indicates the HARQ-disabled resource, wherein transmitting the communication in accordance with the one or more fields or the identifier comprises transmitting the communication using a HARQ-disabled configuration in accordance with the identifier being associated with the SPS configuration.

Clause 22: The method of Clause 21, further comprising: transmitting second DCI associated with a same HARQ process identifier as the first DCI; and transmitting a second communication scheduled by the second DCI using a HARQ-enabled configuration in accordance with a second identifier of the second DCI being associated with dynamic scheduling.

Clause 23: One or more apparatuses, comprising: one or more memories comprising executable instructions; and one or more processors configured to execute the executable instructions and cause the one or more apparatuses to perform a method in accordance with any one of Clauses 1-22.

Clause 24: One or more apparatuses configured for wireless communications, comprising: one or more memories; and one or more processors, coupled to the one or more memories, configured to cause the one or more apparatuses to perform a method in accordance with any one of Clauses 1-22.

Clause 25: One or more apparatuses configured for wireless communications, comprising: one or more memories; and one or more processors, coupled to the one or more memories, configured to perform a method in accordance with any one of Clauses 1-22.

Clause 26: One or more apparatuses, comprising means for performing a method in accordance with any one of Clauses 1-22.

Clause 27: One or more non-transitory computer-readable media comprising executable instructions that, when executed by one or more processors of one or more apparatuses, cause the one or more apparatuses to perform a method in accordance with any one of Clauses 1-22.

Clause 28: One or more computer program products embodied on one or more computer-readable storage media comprising code for performing a method in accordance with any one of Clauses 1-22.

Clause 29: One or more apparatuses configured for wireless communications, comprising: a processing system that includes one or more processors and one or more memories coupled with the one or more processors, the processing system configured to cause the one or more apparatuses to perform a method in accordance with any one of Clauses 1-22.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus for wireless communications, comprising a processing system that includes one or more processors and one or more memories coupled with the one or more processors, the processing system configured to cause a user equipment (UE) to:
receive downlink control information (DCI) associated with a hybrid automatic repeat request (HARQ)-disabled resource; and
process a communication on the HARQ-disabled resource in accordance with one or more fields of the DCI or an identifier of the DCI, wherein the one or more fields or the identifier are interpreted based on the DCI being associated with the HARQ-disabled resource.

2. The apparatus of claim 1, wherein the one or more fields comprise a new data indicator (NDI) field, wherein to cause the apparatus to process the communication in accordance with the one or more fields, the processing system is configured to cause the apparatus to process the communication without regard for whether the communication is an initial transmission or a retransmission.

3. The apparatus of claim 1, wherein the one or more fields comprise a redundancy version identifier (RVID) field, wherein to cause the apparatus to process the communication in accordance with the one or more fields, the processing system is configured to cause the apparatus to process the communication using a default RVID.

4. The apparatus of claim 1, wherein the one or more fields comprise a single field that jointly indicates:
a redundancy version identifier and a new data indicator for a HARQ-enabled resource, and
a HARQ process identifier for the HARQ-disabled resource.

5. The apparatus of claim 1, wherein the one or more fields comprise at least one of a new data indicator (NDI) field or a redundancy version identifier (RVID) field, wherein, in association with the DCI being associated with the HARQ-disabled resource, the one or more fields indicate at least one of:
a modulation and coding scheme,
a resource allocation, or
a transmit power control command.

6. The apparatus of claim 1, wherein the one or more fields comprise a new data indicator (NDI) field based on the HARQ-disabled resource being associated with a reserved modulation and coding scheme, wherein to cause the UE to process the communication in accordance with the one or more fields, the processing system is configured to cause the UE to process the communication using an NDI indicated by the NDI field.

7. The apparatus of claim 1, wherein the HARQ-disabled resource is associated with no reserved modulation and coding scheme, and wherein the DCI is configured to indicate only non-reserved code rates based on the HARQ-disabled resource being associated with no reserved modulation and coding scheme.

8. The apparatus of claim 1, wherein the processing system is configured to cause the UE to transmit, prior to receiving the DCI, uplink control information that indicates a HARQ-disabled configuration for the HARQ-disabled resource.

9. The apparatus of claim 8, wherein the uplink control information is associated with a HARQ acknowledgment for a prior communication prior to the communication.

10. The apparatus of claim 1, wherein the processing system is configured to cause the UE to receive, prior to the DCI, dynamic signaling that indicates a HARQ-disabled configuration for the HARQ-disabled resource.

11. The apparatus of claim 1, wherein the processing system is configured to cause the UE to receive a semi-persistent scheduling (SPS) configuration that indicates the HARQ-disabled resource, wherein to cause the UE to process the communication in accordance with the one or more fields or the identifier, the processing system is configured to cause the UE to process the communication using a HARQ-disabled configuration in accordance with the identifier being associated with the SPS configuration.

12. The apparatus of claim 11, wherein the DCI is a first DCI and the processing system is configured to cause the UE to receive a second DCI associated with a same HARQ process identifier as the first DCI; and
process a second communication scheduled by the second DCI using a HARQ-enabled configuration in accordance with a second identifier of the second DCI being associated with dynamic scheduling.

13. An apparatus for wireless communications, comprising a processing system that includes one or more processors and one or more memories coupled with the one or more processors, the processing system configured to cause a network entity to:
transmit downlink control information (DCI) associated with a hybrid automatic repeat request (HARQ)-disabled resource; and
transmit a communication on the HARQ-disabled resource in accordance with one or more fields of the DCI or an identifier of the DCI, wherein the one or more fields or the identifier are interpreted based on the DCI being associated with the HARQ-disabled resource.

14. The apparatus of claim 13, wherein the one or more fields comprise a redundancy version identifier (RVID) field, wherein to cause the network entity to transmit the communication in accordance with the one or more fields, the processing system is configured to cause the network entity to transmit the communication using a default RVID.

15. The apparatus of claim 13, wherein the one or more fields comprise a single field that jointly indicates:
a redundancy version identifier and a new data indicator for a HARQ-enabled resource, and
a HARQ process identifier for the HARQ-disabled resource.

16. The apparatus of claim 13, wherein the one or more fields comprise at least one of a new data indicator (NDI) field or a redundancy version identifier (RVID) field, wherein, in association with the DCI being associated with the HARQ-disabled resource, the one or more fields indicate at least one of:
a modulation and coding scheme,
a resource allocation, or
a transmit power control command.

17. The apparatus of claim 13, wherein the HARQ-disabled resource is associated with no reserved modulation and coding scheme, and wherein the DCI is configured to indicate only non-reserved code rates based on the HARQ-disabled resource being associated with no reserved modulation and coding scheme.

18. The apparatus of claim 13, wherein the processing system is configured to cause the network entity to receive, prior to receiving the DCI, uplink control information that indicates a HARQ-disabled configuration for the HARQ-disabled resource.

19. The apparatus of claim 13, wherein the processing system is configured to cause the network entity to transmit, prior to the DCI, dynamic signaling that indicates a HARQ-disabled configuration for the HARQ-disabled resource.

20. A method for wireless communications by a user equipment (UE) comprising:
receiving downlink control information (DCI) associated with a hybrid automatic repeat request (HARQ)-disabled resource; and
processing a communication on the HARQ-disabled resource in accordance with one or more fields of the DCI or an identifier of the DCI, wherein the one or more fields or the identifier are interpreted based on the DCI being associated with the HARQ-disabled resource.
